(19) United States
(12) Patent Application Publication
(10) Pub. No.: US 2003/0110298 A1
(43) Pub. Date: Jun. 12, 2003

(54) HAVi-UPnP bridging

(75) Inventor: Peter J. Lanigan, Croydon (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/304,244

(22) Filed: Nov. 26, 2002

(30) Foreign Application Priority Data
Dec. 6, 2001 (GB) 0129177.2

(51) Int. Cl. G06F 15/16

(52) U.S. Cl. 709/246; 709/249; 709/203

(57) ABSTRACT

A bridge (40) provides access to a device (25) on a first network (20) to a second network (30). The bridge (40) provides a description (55) of the device (25) to the second network (20), the description (55) includes a link to a controller (65) accessible from the second network (30). The controller (65) provides access to the device (25) such that a device (35) on the second network (30) is able to access the controller (65) and thereby subsequently access the device (25) on the first network (20) using the description (55).

The present invention relates to bridging HAVi and UPnP networks and is particularly applicable for use in home networks.

The number of consumer electronic devices and other home appliances with processing capabilities is constantly increasing. A comparable increase can also be seen in the number of computers, peripherals and other computer hardware used in the typical home or office. A number of competing standards and protocols have emerged, allowing the devices and appliances to be networked and communicate. It is common for a single manufacturer to implement a control system that allows its devices and appliances to communicate, possibly share data and control each other. For example, a television may control a video or stereo. However, it is often the case that the protocol or standard used by an appliance or device from one manufacturer will not be compatible with that of another manufacturer and therefore cannot control or communicate with other devices and appliances of that other manufacturer.

It is obviously desirable for a single standard to be agreed that will allow all manner of digital consumer electronics, home appliances, computers and the like to communicate with each other. With the arrival of broadband communications infrastructure and the digitization of audio and video appliances, such systems have been implemented giving simple control over complex technology.

Unfortunately, the realisation of a single standard is still some way off. Several networks based on different physical media (wired and wireless) and applications are expected to coexist in a digital home network. Common examples of wired physical media include the coaxial cable, twisted pair wiring, power line and optical fibres. A digital home network also needs to contend with the technological developments within the computer, consumer electronics, telephony and home automation industries. In order to address the differing needs required by differing physical media two standards have evolved:

1. Home Audio-Video interoperability (HAVi)

2. Universal Plug and Play (UPnP)

The first standard, Home Audio-Video interoperability (HAVi), started within the consumer electronics industry as an attempt to accomplish high-speed interconnectivity over an IEEE 1394 serial bus network for transacting audio-visual data. HAVi is a digital Audio-Visual (AV) networking initiative that provides a home networking software specification for seamless interoperability among home entertainment products. The HAVi specification is AV-device-centric and has been designed to meet the particular demands of digital audio and video. It defines an operating-system-neutral middleware that manages multi-directional AV streams, event schedules, and registries, while providing application program interfaces (APIs) for the creation of a new generation of software applications. HAVi software takes advantage of the powerful resources of chips built into modern audio and video appliances to give you the management function of a dedicated audio-video networking system. Devices and components are represented by Device Control Modules (DCMs) in a HAVi network whilst services and functionality offered by devices and components are represented by Functional Control Modules (FCMs). Each DCM and FCM is seen as an entity on the HAVi network that other entities can interact with and use. Within HAVI, there is a strong emphasis on enabling streaming applications in addition to control applications. An example of a streaming application would be an application transferring a video stream from a recording device to a decoder or display, while an example of a control application would be an application for programming the behaviour of devices. This implies support for both isochronous and asynchronous transactions.

The second standard is Universal Plug and Play (UPnP). While HAVI is intended primarily for a high speed IEEE 1394 network for Audio-Video (AV) transactions, UPNP can be implemented over many types of network (or within a PC). UPnP uses a version of the TCP/IP protocol stack and the Web to enable seamless proximity networking in addition to control and data transfer among networked devices in the home, office, and everywhere in between. The general notions and paradigms are based on the Internet protocols with additions to support the notions of plug and play. It enables data communication between any two devices under the command of any control device on the network. UPnP is independent of any particular operating system, programming language, or physical medium. Entities representing networked devices within a UPnP network include devices and services.

At present, there is no interoperability between the different standards to ensure that uniform control is possible. Devices within the HAVi network cannot interact and perform control functions with devices within UPNP network and vice-versa.

It will be appreciated that there is a need for harmonization of the two system approaches in order to ensure coexistence and interoperability of devices within these domains. The bridging of the two technological approaches, is thus desirable.

HAVi ML is an extension of XML that allows HAVi communications and data to be transported over an HTTP or other suitable connection. One use of this has been to transport a user interface (UI) to a remote IP device and display the UI on that device. Logically (from a HAVi point of view), all of the software elements executed in this way are running on one device.

According to a first aspect of the present invention, there is provided a bridge for providing access to a device on a first network to a second network, the bridge providing a description of the device to the second network, the description including a link to a controller accessible from the second network, the controller providing access to the device, wherein a device on the second network is able to access the controller and thereby subsequently access the device on the first network using the description.

HAVi ML software is written as Java applets on web pages which can be downloaded by a remote web browser. The applet contains the HAVi ML software, which can upload havlets (or other HAVi UI applications). In this way, standard HAVi UIs can be displayed within a web browser running on a device that knows nothing of HAVi or IEEE1394.

The first network may be a Home Audio-Video interoperability, HAVi, network.

The second network may be a Universal Plug and Play, UPnP, network.

The controller may comprise a user interface. Preferably, the controller is embedded in a web page accessible from the second network. The link in the description may be the unique resource locator, URL, of the web page. The controller may be a Java applet such as a HAVi ML havlet.

The controller may provide access to a plurality of devices on the first network. Alternately, the controller may provide access to the first network and all devices connected to the first network.

According to a second aspect of the present invention, there is provided a method for providing access to a device on a Home Audio-Video interoperability, HAVi, network from a Universal Plug and Play, UPnP, network comprising:

bridging the HAVi and UPnP networks;

generating a controller accessible from the UPnP network for providing access to the device; and,

advertising a description of the device on the UPnP network, the description including a link to a controller,

wherein a device on the second network is able to access the controller and thereby subsequently access the device on the first network using the description.

Examples of the present invention will now be described in detail with reference to the accompanying drawings, in which:

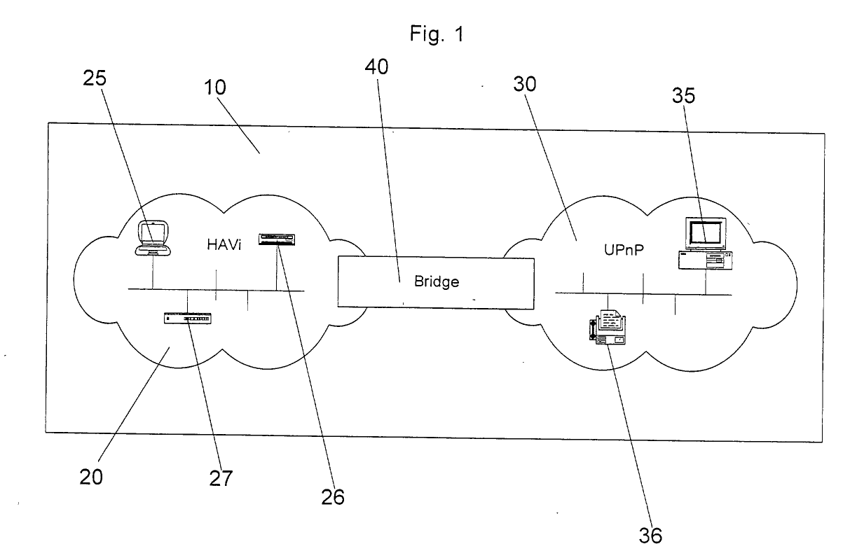

FIG. 1 is a schematic diagram of a HAVi network and a UPnP network linked through a bridging device according to an embodiment of the present invention;

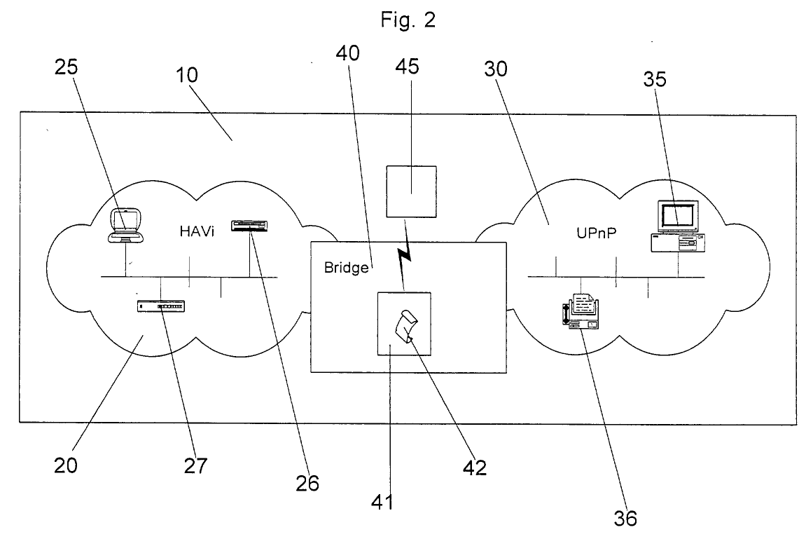

FIG. 2 is the schematic diagram of FIG. 1 illustrating selected features in greater detail;

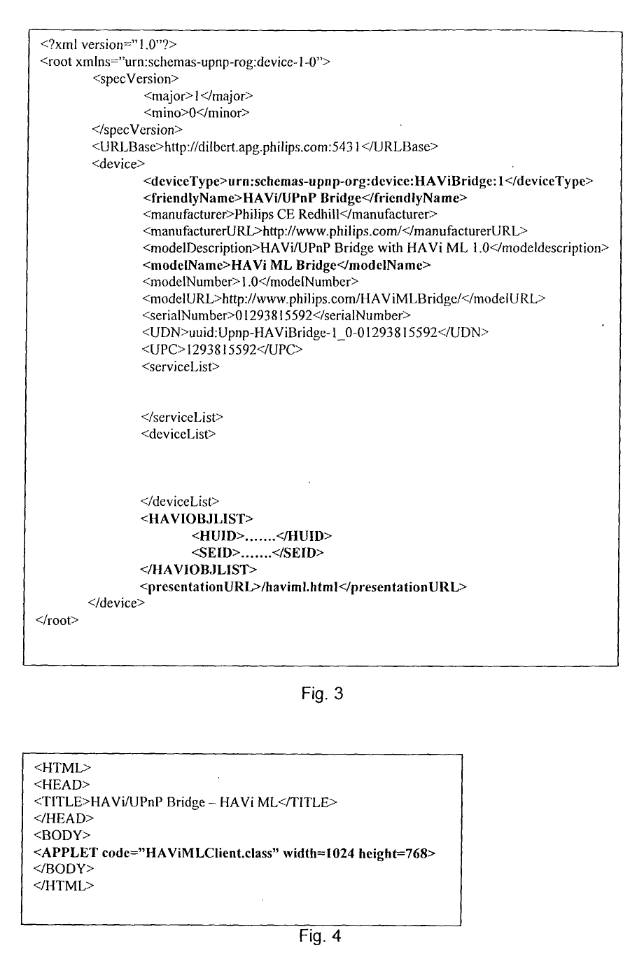

FIG. 3 is an XML UPnP device description;

FIG. 4 is an example HTML script for a web page corresponding to a presentation URL for accessing a HAVi ML Java applet; and,

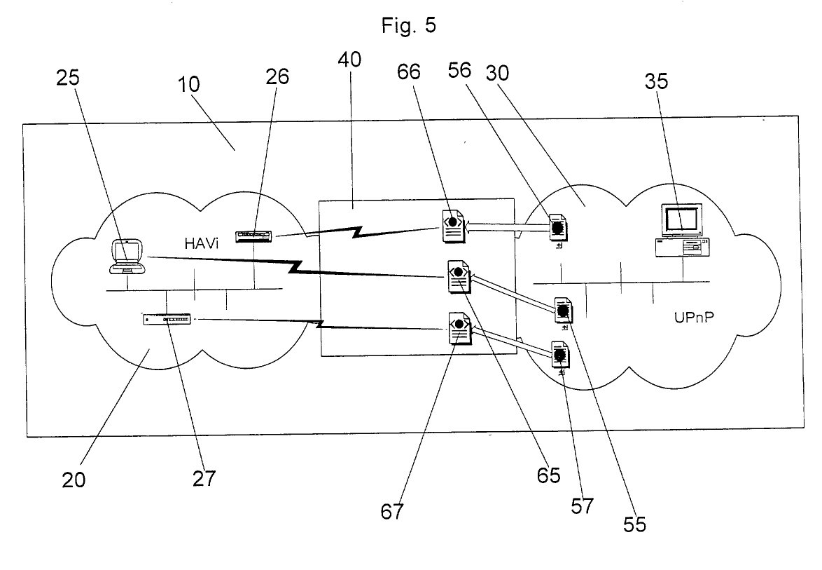

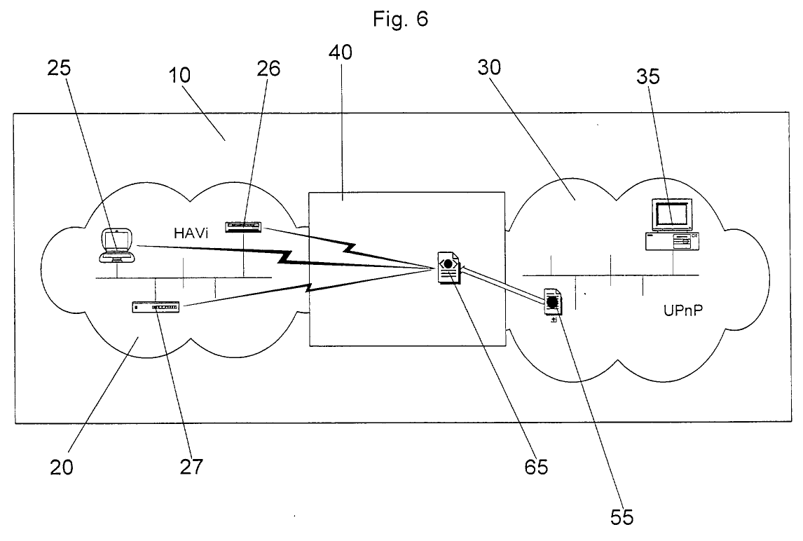

FIGS. 5 and 6 are schematic diagrams illustrating embodiments of the bridge of FIGS. 1 and 2 in operation.

FIG. 1 is a schematic diagram of a HAVi network and a UPnP network linked through a bridging device according to one embodiment of the present invention. A network 10 includes a HAVi based network 20 and a UPnP based network 30 that are bridged together by a bridge 40.

Node 35 is a UPnP control point where the user can view the network topology and can control, through an appropriate user interface, any node (25, 26, 27, 36) on either network 20, 30. From node 35, the user can, for example, detect the appearance of a new HAVi device within the HAVi network 20 and can control it.

The bridge 40 provides UIs for devices in the HAVi network 20 to the UPnP network 30. The node 35 is able to access a UI from the bridge 40 for devices (25, 26, 27) within the HAVi network 20 and use it to control them.

In FIG. 1, the two networks 20, 30 are shown as each using a different physical media. However, the present invention is equally applicable where HAVi and UPnP networks are implemented over the same physical media.

FIG. 2 is the schematic diagram of FIG. 1 illustrating selected features in greater detail. A suitable UI is implemented as an embedded HAVi ML applet 42 within a web page 41 on the bridge 40. The applet 42 contains a HAVi ML client which, in communication with a HAVi ML server 45 on the bridge 40, provides a UPnP control node 35 with an environment within which HAVi software elements can be run.

The bridge 40 advertises the UI as a UPnP device to the UPnP network 30. No functional description or services are included within the advertisement. Instead a presentation URL points to the web page 41 from which the UI can be obtained. In this manner, any SE (Software Element) which can run in a HAVi ML environment, including any uploaded havlets, can run on any suitable UPnP control point.

FIG. 3 is an XML UPnP device description that advertises a bridged HAVi device with a presentation URL of <path>/haviml.html. Obviously other tags may be included depending on the bridge configuration. A number of lines within the Figure are highlighted in bold. These lines provide information on the HAVi device for implementation on the UPnP network. In particular:

| Tag | Function |
|---|---|
| <deviceType> | States that the device is a HAVi bridge. |
| <friendlyName> | Specifies a name that can be presented to a user. As |
| | the bridge is transparent, this may never be used but |
| | is required by UPnP standards. |
| <modelName> | Specifies a hardware/network name for the bridge. |
| <HAVIOBJLIST> | Lists HAVi software elements (HUIDs or SEIDs) |
| | represented by the bridge. These may be used to |
| | prevent bridging them back to the HAVi domain or |
| | representing them twice in the UPnP domain. |
| <presentationURL> | Specifies a web page containing an associated |
| | HAVi ML application. |

FIG. 4 is an example HTML script for a web page corresponding to the presentation URL for accessing the HAVi ML Java applet. The bold text indicates the line of script that causes a client uploading the script to load the Java class that runs the HAVi ML client.

FIGS. 5 and 6 are schematic diagrams illustrating embodiments of the bridge of FIGS. 1 and 2 in operation.

In FIG. 5, the bridge 40 provides a user interface in the form of an advertised XML description and corresponding web page and HAVi ML applet for each HAVi device exported by the bridge 40 from the HAVi network 20.

HAVi devices 25, 26 and 27 are detected by the bridge 40. For each device (25, 26, 27), the bridge generates an appropriate XML description 55, 56, 57 and HTML presentation web page 65, 66, 67 from stored template files. The XML descriptions are advertised to the UPnP network 30. A device 35 on the UPnP network 30 having a suitable control point receiving the advertisements is able to follow the presentation URLs within the XML descriptions 55, 56, 57 to the HTML presentation web pages 65, 66, 67. A web browser within the device 35 is then able to upload and use the UI provided by the presentation web pages 65, 66, 67. One UPnP device is required per exported UI for a HAVi device. The UPnP devices are dynamically created and destroyed (and advertised in the normal UPnP manner) as havlets become available or are removed from the network.

In FIG. 6, the bridge 40 provides a single user interface in the form of an advertised XML description 55 and corresponding web page 65 and HAVi ML applet for all HAVi devices (25, 26, 27) exported by the bridge 40 from the HAVi network 20. In this embodiment the HAVi ML applet represents the entire HAVi network 20 and updates itself whenever the network changes. The UI allows the user to choose a HAVi device to view and control.

Although the bridge provides access to HAVi devices on a UPnP network, a device may be capable of existing in both the HAVi and UPnP network. In such a case it may be preferable to use the bridge-provided UI over controlling the actual device or vice-versa. Furthermore it may be preferable to prevent the bridge providing a UI for a HAVi device that is already present on the UPnP network (this would also prevent a feedback of objects from one network being represented by the bridge on another and then bridged back again, especially if there is more than one bridge in the network). To avoid such problems the virtual representations are identified as such by a unique identifier for the device they represent.

Examples of achieving the virtual representation include defining a new XML tag for UPnP descriptions:

<HAVIHUID>representation of an HUID</HAVIHUID>

where the presence of the tag would indicate that the description represent a HAVi object.

1. A bridge for providing access to a device on a first network to a second network, the bridge providing a description of the device to the second network, the description including a link to a controller accessible from the second network, the controller providing access to the device, wherein a device on the second network is able to access the controller and thereby subsequently access the device on the first network using the description.

2. A bridge according to claim 1, in which the first network is a Home Audio-Video interoperability, HAVi, network.

3. A bridge according to claim 1 in which the second network is a Universal Plug and Play, UPnP, network.

4. A bridge according to claim 1 in which the controller comprises a user interface.

5. A bridge according to claim 1, in which the controller is embedded in a web page accessible from the second network.

6. A bridge according to claim 5, in which the link in the description is the unique resource locator, URL, of the web page.

7. A bridge according to claim 5, in which the controller is a Java applet.

8. A bridge according to claim 4, in which the controller is a HAVi ML havlet.

9. A bridge according to claim 1, in which the controller provides access to a plurality of devices on the first network.

10. A bridge according to claim 1, in which the controller provides access to the first network and all devices connected to the first network.

11. A method for providing access to a device on a Home Audio-Video interoperability, HAVi, network from a Universal Plug and Play, UPnP, network comprising:
bridging the HAVi and UPnP networks;
generating a controller accessible from the UPnP network for providing access to the device; and,
advertising a description of the device on the UPnP network, the description including a link to a controller,
wherein a device on the second network is able to access the controller and thereby subsequently access the device on the first network using the description.

12. A computer program comprising computer program code means for performing all the steps of claim 11 when said program is run on a computer.

13. A computer program as claimed in claim 12 embodied on a computer readable medium.
